(19) United States
(12) Patent Application Publication
(10) Pub. No.: US 2007/0270071 A1
(43) Pub. Date: Nov. 22, 2007

(54) Nonwoven fabric towel

(76) Inventors: J. Travis Greer, Moore, SC (US); Paul E. Dodd, Simpsonville, SC (US); Karen H. Stavrakas, Greenville, SC (US); Nathan B. Emery, Spartanburg, SC (US)

Correspondence Address: Legal Department (M-495), P.O. Box 1926, Spartanburg, SC, 29304, US

(21) Appl. No.: 11/436,865

(22) Filed: May 18, 2006

(51) Int. Cl. B32B 3/06; B32B 7/02; D04B 7/12; D04H 1/00

(52) U.S. Cl. 442/414; 442/361; 442/415; 428/102; 66/190; 428/218

(57) ABSTRACT

The invention relates to a nonwoven fabric towel comprising about 25 to 75% by weight a first fiber comprising a polyester or polyester co-polymer staple fiber having a staple length of between 3 and 6 inches and a surface area per unit length of between approximately 0.2 micrometer²/cm to 1.2 micrometer²/cm, about 25 to 50% by weight a second fiber comprising a multi-segment splitable staple fiber comprising a first component being a polyester or polyester co-polymer component and a second component being a polyamide component or a polyester or polyester co-polymer incompatible with the first component, wherein weight ratio of the first component and the second component is between 40:60 and 80:20, and wherein the first component and the second component have a denier per staple filament of between 0.05 and 0.5, wherein the nonwoven fabric towel is bonded with a stitches of a bulkable yarn, and wherein at least the first or second fiber comprises a hydrophilic surface treatment.

### BACKGROUND

In an industrial laundry industry, cotton towels are laundered and rented to customers for the cleaning of kitchens, tables, walls, bar tops and a host of other miscellaneous duties. The range of uses for the towels creates an environment where the product is subjected to much abuse. These towels are not ideal for all of these applications because of a lack of strength, propensity to lint, poor dimensional stability and susceptibility to degradation from chlorine bleach. Degradation in the presence of chlorine is a particular problem with the longevity of the product because US DHEC (Department of Health and Environmental Control) regulations state that restaurants are required to soak their cleaning towels in a chlorine bleach solution for health reasons. Also, industrial laundries must bleach the towels heavily in the wash cycle to remove the tremendous loading of stains, grease, and particulate from the towels. For these reasons, the towels have a very short life span and are not as durable as the laundries or restaurants would prefer. The wear and abuse the towels endure also cause tears and holes in the product which is not desirable to restaurants and other customers because they look dirty and worn in front of their clients and project a poor image for the company.

There is a need for a nonwoven fabric towel with excellent absorbency, durability, cleanability, and chlorine resistance while having good hand. All patents and patent applicants cited are incorporated by reference in their entirety.

### BRIEF DESCRIPTION OF THE DRAWINGS

An embodiment of the present invention will now be described by way of example, with reference to the accompanying drawings.

FIG. 1 is a view of one embodiment of the nonwoven fabric towel.

### DETAILED DESCRIPTION

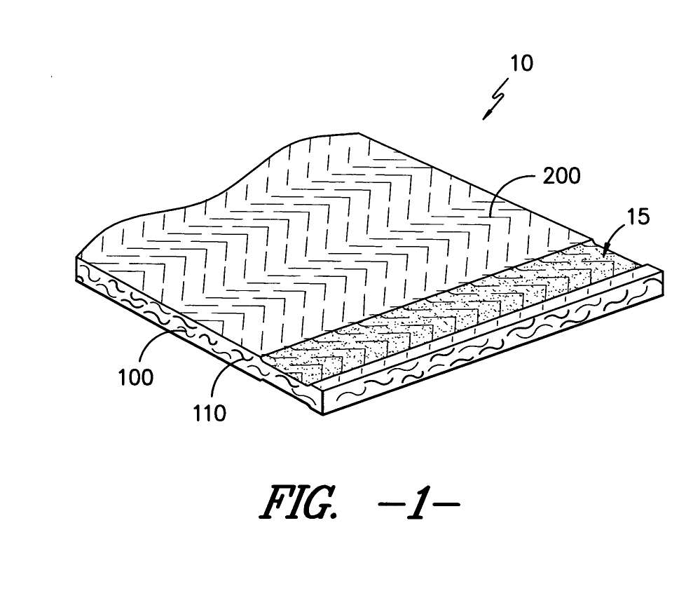

Referring now to FIG. 1, there is shown a nonwoven fabric towel 10 that may be, for example, a cleaning towel. The nonwoven fabric towel 10 includes a first staple fiber 100 and a second staple fiber 110. The nonwoven layer is bonded with stitches of a bulkable yarn 200 and at least one of the fibers is treated with a hydrophilic surface treatment. The nonwoven fabric towel 10 may be ultrasonically sealed as shown as edge region 15. The nonwoven fabric towel has been shown to have excellent absorbency, durability, and chlorine resistance while having good hand.

The nonwoven fabric towel 10 comprises about 40 to 75% by weight of the first fiber 100 and about 25 to 50% wt of the second fiber 110. More preferably, the nonwoven towel comprises about 65 to 75% by weight the first fiber and 25 to 35% by weight the second fiber. A nonwoven towel formed from with 75% wt first fiber and 25% wt second fiber and a nonwoven towel formed with 65% wt of the first fiber and 35% wt of the second fiber have been shown to have the desired physical characteristics such as absorbency, durability, and chlorine resistance. It is understood that minor amounts of other fibers or additives may be included to provide additional features such as antistatic.

The term “nonwoven fabric or web” means a web having a structure of individual fibers, yarns, or threads which are interlaid, but not in a regular or identifiable manner as in a knitted fabric. Nonwoven fabrics or webs can be formed from many processes such as, for example, meltblowing processes, spunbonding processes, air laying processes, and bonded carded web processes. Carded and needled punched nonwoven webs are preferred for their good mechanical strength webs produced.

The first fiber 100 is a polyester or polyester co-polymer staple fiber with an average staple length of between about 3 and 6 inches (7.6 and 16.2 cm) and a surface area per unit length of between approximately 0.2 micrometer²/cm to 1.2 micrometer²/cm. A staple length of less than 2.5 inches has been found to create a product that is more susceptible to linting, pilling and wear. If the staple lengths are significantly greater than 6 inches, the fibers would require a different manufacturing process and approach being more similar to a spunbonded, continuous filament product. In one embodiment, the denier of the first fiber 100 is between 0.25 to 3, more preferably between 2 and 3. This range has been found to create fibers with high surface area, good water absorption characteristics, and strength as well.

Preferably, the fiber is a synthetic fiber that is resistant to chlorine bleach. Many natural fibers have good absorbency, but degrade in chlorine, limiting their useful life span as a commercial reuseable cleaning towel. The nonwoven towels of the invention will be exposed to high heat when used as a cleaning product in kitchens around ovens and grills. Polyester and its co-polymers are particularly suited due to a high melting point versus other synthetics such as polypropylene. Polyethylene terephthalate (PET) is readily available, low cost and can be made hydrophilic with chemical modification. The polyester or polyester co-polymer may also be, but is not limited to polytrimethylene terephthalate (PTT), polycyclohexane dimethylene terephthalate (PCT), polybutylene terephthalate (PBT), PET modified with polyethylene glycol (PEG), and polylactic acid (PLA). PTT fibers have a slightly lower melting temperature and tend to be softer and give good abrasion resistance. PCT fibers have a higher melt point and PBT fibers have a slightly lower melt point. PET modified with PEG, has improved absorbency.

In one embodiment, the first fiber has round cross-sectional shape. The round shape has a lower bending modulus than other cross-sections which adds to the good hand and drape and round cross-sectional fibers tend to be easily produced and less expensive.

The second fiber 110 is a multi-segment, splittable staple fiber. The term “multi-segment splittable staple filaments” refers to multi-component filaments, which split lengthwise into finer filaments of the individual thermoplastic polymer segments when subjected to a stimulus. In one embodiment, this stimulus is mechanical, but other stimuli such as chemicals may be employed. The staple filaments contain at least two incompatible polymers arranged in distinct segments across the cross-section of each staple filament. The incompatible components are continuous along the length of each staple filament. The individual components of each staple filament split apart from each other when the filament is subjected to a stimulus, resulting in finer individual filaments formed from the segments.

The splittable fiber is made up of at least a first component and a second component. The first component is a polyester or polyester co-polymer component, including but not limited to PET, PTT, PCT, PBT, PET modified with PEG, and PLA. The second component is a polyamide component or a polyester or polyester co-polymer that is incompatible with the polyester or polyester co-polymer in the first component. The polyester or polyester co-polymer may be, but is not limited to PTT, PCT, PBT, PET, and PET modified with PEG. The polyamide may be, but is not limited to nylon and the polyesters or co-polymers above as long as they are incompatible with first polyester component in such a way as they will split. Nylon is preferred due to increased tenacity, high moisture regain, and great natural affinity for water. The first component and second component are in a weight ratio of between 40:60 and 80:20. For maximum productivity, a roughly 50:50 ratio is preferred. Both the first and second components have a staple filament denier of between 0.05 and 0.5, more preferably between 0.15 and 0.5.

The deniers of the first fiber 100 and the second fiber 110 are preferably different. Surface tensions of the two fibers are different because of the differing deniers, creating a tension gradient that causes the movement of water throughout the structure.

The nonwoven fabric towel 10 is bonded with stitches of a bulkable yarn 200 giving the towel durability. Preferably, the towel is stitchbonded or quilted. In one embodiment, the stitchbonding is done in a herringbone pattern. The herringbone stitch is preferred because it creates the greatest dimensional stability in the product and results in low wash shrinkage. Other stitches include Tricot and 3 and 4 Row Atlas. The row spacing between the stitches usually is in the range of 2 to 10 rows per centimeter, in one embodiment 3 to 6 per cm. The stitch spacing usually is in the range of 2 to 15 stitches per cm, in one embodiment 4 to 12 per cm. The stitches of a bulkable yarn may also be accomplished using a warp knit machine.

Suitable bulkable yarns includes textured, DTY (draw textured yarn), SDY (spun drawn yarn), FOY (fully oriented yarn), threads or yarns of polyester, nylon, or the like, and composite yarns such as elastomeric yarn (e.g., elastomerics such as Lastol-P® available from Dow's XLA generic or high temperature Lycra®) in an extended state wrapped with inelastic nylon or polyester. As used herein, the term “bulkable yarn” refers to a thread or yarn which shrinks causing the fabric to be “bulked” by being deformed out-of plane. The deformation is induced by releasing tension from the yarn or by exposing the yarn to chemical action, moisture and/or heat at a temperature of about 50 to 200° C. Usually, the stitchbonded nonwoven fabric has a unit weight in the range of 10 to 300 grams per square meter, in one embodiment 100 to 250 g/m²

Bulking of the bulkable yarns (a) increases entanglement of the threads with the fibrous layer and enhances fabric stability and durability, and (b) causes gathering of the fabric, which results in a softer hand, improved drape, and decreased stiffness.

At least one of the fibers (the first fiber 100 or the second fiber 110) is treated with a hydrophilic surface treatment. Preferably, the hydrophilic surface treatment is durable. In this application “durable” is defined to be that the hydrophilic surface treatment is still on the fibers in an amount of at least 200 ppm after 30 industrial washes. This treatment may be applied during the manufacture of the fibers, applied to the fibers, or applied to the finished towel. The hydrophilic agents may be applied by spraying, foam coating, dye jetting, padding, applying during yarn formation, or included in the yarn formation.

The term “hydrophilic” as used herein indicates affinity for water. The hydrophilicity of the hydrophilic component polymer can be measured in accordance with the ASTM D724-89 contact angle testing procedure on a film produced by melt casting the polymer at the temperature of the spin pack that is used to produce the conjugate fibers. Desirably, the hydrophilic polymer component has an initial contact angle less than about 90 degrees, more desirably equal to or less than about 75 degrees, even more desirably equal to or less than about 60 degrees, most desirably equal to or less than about 50 degrees. The term “initial contact angle” as used herein indicates a contact angle measurement made within about 5 seconds of the application of water drops on a test film specimen.

In one embodiment, the fabric may be treated with an anionic-ethoxylated sulfonated polyester (AESP, surfactant/stabilizer agent) and a high molecular weight ethoxylated polyester (HMWEP, lubricant/softener agent). This treatment allows the fabric to absorb water very rapidly and promotes wicking, water transport, and dissipation through the fabric, and liquid retention, with the result being that the surface of the fabric quickly feels dry to the touch. The treatment also helps to prevent staining, improves washing performance and reduces creasing.

Other hydrophilic treatments include: non-ionic soil release agents having oxyethylene hydrophiles, such as the condensation polymers of polyethylene glycol and/or ethylene oxide addition products of acids, amines, phenols and alcohols which may be monofunctional or polyfunctional, together with binder molecules capable of reacting with the hydroxyl groups of compounds with a poly (oxyalkylene) chain, such as organic acids and esters, isocyanates, compounds with N-methyl and N-methoxy groups, bisepoxides, etc. Particularly useful are the condensation products of dimethyl terephthalate, ethylene glycol and polyethylene glycol (ethoxylated polyester) and ethoxylated polyamides, especially ethoxylated polyesters and polyamides having a molecular weight of at least 500, as well as soil release agents described in the following patents. Additional hydrophilic treatments may be found in U.S. Pat. No. 7,012,033, incorporated herein by reference.

In one embodiment, the outer edge region 15 of the nonwoven fabric towel 10 is ultrasonically sealed and/or slit. The are of the towel that is ultrasonically sealed may be the outer most edge of the towel or may be slightly in from the edge as shown in FIG. 1. The polymers used in the nonwoven fabric towel (polyester, polyester co-polymers, and polyamides) are thermoplastics and ultrasonically fusible fibers, meaning that the fibers will melt when subjected to enough ultrasonic energy. Ultrasonic slitting and sealing uses acoustic energy to melt the fibers of the nonwoven towel together to prevent fraying of the edges of the towel. The vibrational energy of an ultrasonic horn is converted to heat due to intermolecular friction that melts and fuses the two parts. When the vibrations stop, the fabric solidifies joining the fibers together.

With ultrasonic slitting, the towels may be is cut and sealed in one step saving process steps and money. Ultrasonics can operate at relatively high speeds making it a quick processing step.

In one embodiment, the nonwoven fabric towel 10 comprises an antimicrobial treatment. This treatment may be applied during the manufacture of the fibers, applied to the fibers, or applied to the finished towel. Antimicrobial chemistries that may be applied include, but are not limited to inorganic silver-based ion-exchange compounds (available as Alphasan®), zeolite compounds, nanosilver, hindered amines, halamines, and zinc oxide. It is preferred to have an antimicrobial chemistry that is durable so that the towel maintains its antimicrobial characteristics through laundering and use.

In one embodiment, the nonwoven fabric towel 10 has a density of between 100 and 200 grams per square meter. This creates a light weight towel with good absorption and physical durability.

The nonwoven fabric towel 10 preferably has an absorbency of aqueous solutions of at least 400% by weight of the towel. Additionally, the towel preferably has a stoll flat abrasion results of greater than 500 cycles after 30 industrial washes as tested by ASTM D3886-99.

Preferably, the nonwoven fabric towel 10 has durability to commercial laundering. After 30 industrial washes, the nonwoven towel preferably has a tongue tear strength of at least 10 lb-f as tested by ASTM 2261 Additionally, the nonwoven fabric towel 10 preferably has a grab tensile strength of at least 50 lb-f as tested by ASTM D5034, and a sled friction of greater than 0.15 as tested by ASTM D1894 (friction is desired for picking up kitchen objects such as pots and pans) after 30 industrial washes.

In one embodiment, the nonwoven fabric towel 10 has a tongue tear of at least 10 lb-f in the warp and weft directions after being subjected to a chlorine test consisting of a series of 2 industrial washes and dryings and an overnight soaking in a 5% bleach solution repeated 5 times. Additionally, the nonwoven fabric towel 10 preferably has a tensile strength of at least 50 lb-f (pound force) in the warp and weft directions after the after the chlorine test.

The nonwoven fabric towel of the invention may be used as towels, sport towels, salon towels, automotive and transportation wash towels, retail bath towels, cabinet roll towels, barmops, restaurant cleaning towels, industrial and commercial cleaning towels, table skirting, table pads, and pharmaceutical and chemical absorbents.

### EXAMPLES

The towel of the invention was compared to towels of differing composition and a commercially available woven cotton towel. The non-woven towels of examples 1-4 had a density of approximately 6 oz/yd². The splittable fiber was a 6 denier fiber that was formed of 16 segments polyester and nylon. The fibers were 3 inches long. The round fiber was a 2.25 denier polyester, 4 inch long fiber.

Each of the non-woven examples 1-4 were stitched with three different stitches with the different warp yarns. The three stitches used were a chain tricot, an atlas 2-needle, and a herringbone stitch. The three different warp yarns used were a textured polyester yarn, a flat polyester yarn with shrinkage of approximately 6%, and a flat polyester yarn with shrinkage of approximately 12%.

Comparison example 5 was a commercially available 100% cotton woven towel of approximately 11 oz/yd² available from Baltic™. Comparison example 6 was a towel comprised of 100% by weight 4 denier round polyester staple fibers with an average fiber length of 4 inches.

The percentage of the different fibers components of each of the examples is listed in Table 1. All percentages are by weight unless otherwise noted.

TABLE 1
Compositions of invention and comparison examples

| | Splittable Fiber | Round Fiber | Cotton Fiber |
|---|---|---|---|
| Inv. Ex. 1 | 25% | 75% | 0% |
| Comp. Ex. 2 | 50% | 50% | 0% |
| Comp. Ex. 3 | 12.5% | 87.5% | 0% |
| Comp. Ex. 4 | 0% | 100% | 0% |
| Comp. Ex. 5 | 0% | 0% | 100% |

For testing, each of the example towels were washed and dried according to standard commercial laundering procedures with detergent and bleach added each wash cycle for 50 washes. The wash formula is listed below:

| Load | 80% capacity (28 lb load in a 35 lb Milnor front-load machine | | | |
|---|---|---|---|---|
| Dryer | 50 lb gas dryer set | | | |
| Chemical | WSI ® | | | |
| Supplier | | | | |
| | | Temperature | Water | |
| Operation | Time (min) | (° F.) | Level | Chemical Usage |
| Flush | 2 | 165 | high | |
| Wash | 15 | 165 | low | 8 oz. Express ® |
| | | | | 3 oz. Alpha ® |
| | | | | 2 oz. Horizon ® |
| Carryover | 5 | 165 | low | |
| Flush | 2 | 165 | high | |
| Flush | 2 | 165 | high | |
| Flush | 2 | 165 | high | |
| Bleach | 8 | 145 | low | 12 oz. Clorox ® |
| Rinse | 2 | 130 | high | |
| Rinse | 2 | 110 | high | |
| Rinse | 2 | 100 | high | |
| Sour | 5 | cold | low | 0.5 oz. Pinnacle |
| | | | | Sour ® |
| | | | | 0.4 oz. Antichlor ® |

| | | |
|---|---|---|
| Extract | 8 | Extraction preformed |
| | | at low speed |

The sample were then quantitatively tested for physical characteristics and given a passing or failing grade as shown in Table 2.

TABLE 2
Examples physical characteristics of examples after 50 wash test

| | Absorbency | Strength | Pilling | Yellowing |
|---|---|---|---|---|
| Inv. Ex. 1 | pass | pass | pass | pass |
| Comp. Ex. 2 | pass | pass | pass | fail |
| Comp. Ex. 3 | fail | pass | pass | pass |
| Comp. Ex. 4 | fail | pass | pass | pass |
| Comp. Ex. 5 | pass | fail | fail | pass |

As can be seen from Table 2, only the invention example 1 passed all of the required physical characteristics. The woven cotton comparison example 5 had good absorbency, but suffered from pilling and loss of strength after washing. Comparison examples 3 and 4 with low amounts of the splitable fiber had poor absorption. Comparison example 4 additionally had poor feeling hand. Comparison example 2, which had 50% by weight of the splitable fibers suffered from yellowing due to the nylon in the splitable fibers.

For the warp stitches in examples 1-4, the herringbone stitch was the selected as the best because of hand and feel. The chain tricot and the Atlas 3-needle when stitched and washed tended to come to the surface of the sample, making the user feel the warp stitches more than the non-woven material which is undesirable.

The warp yarn stitches for examples 1-4 were stitched with the textured yarn, the 6% shrinkage yarn and the 12% shrinkage yarn. The 6% shrinkage yarn was preferred because the 12% shrinkage yarn shrank too much causes the fabric to bunch up and the textured yarn with essentially no shrinkage did not create enough bulk in the nonwoven.

Invention example 1, stitched with the 6% shrinkage warp yarn in a herringbone pattern was compared quantitatively with comparison example 5.

One of the tests was a tongue tear tested according to ASTM D 2261 which gives a good indication of durability of the towels. It was determined that as received (AR), both the warp direction and the fill direction should have tongue tear strength of at least 15 lb-f. After 30 washes, for the towel to have good durability, the towel should have tongue tear strength of at least 10 lb-f in both the warp and fill directions. The tongue tear results for AR and after 30 washes are found in Table 3.

TABLE 3
Tongue strength results for AR and after 30 washes in lb-f

| | Requirement | | Inv. Ex. 1 | | Comp. Ex. 5 | |
|---|---|---|---|---|---|---|
| | AR | 30 Washes | AR | 30 Washes | AR | 30 Washes |
| Warp | >15 lb-f | >10 lb-f | 26.0 lb-f | 13.2 lb-f | 8.4 lb-f | 5.3 lb-f |
| Dir. | | | | | | |
| Fill | >15 lb-f | >10 lb-f | 25.1 lb-f | 14.3 lb-f | 7.3 lb-f | 2.8 lb-f |
| Dir. | | | | | | |

Another test for durability is grab tensile, tested according to ASTM D5034. Table 4 shows the requirements for grab tensile AR and after 30 washes and the testing results.

TABLE 4
Grab tensile strength results AR and after 30 washes in lb-f

| | Requirement | | Inv. Ex. 1 | | Comp. Ex. 5 | |
|---|---|---|---|---|---|---|
| | | 30 | | 30 | | 30 |
| | AR | Washes | AR | Washes | AR | Washes |
| Warp | >50 lb-f | >50 lb-f | 212.5 lb-f | 146.1 lb-f | 36.0 lb-f | 22.9 lb-f |
| Dir. | | | | | | |
| Fill | >50 lb-f | >50 lb-f | 150.2 lb-f | 121.2 lb-f | 30.6 lb-f | 23.0 lb-f |
| Dir. | | | | | | |

The data shows that the invention example 1 meets and exceeds the required durability, while the comparison example 5 does not meet the required durability.

Other important physical characteristic of a towel is its slickness which controls how well the towel is able to be used to pick up dishes, pots, and pans. Table 5 shows the sled friction dry/static as tested by ASTM D1894.

TABLE 5
Sled friction test AR and after 30 washes

| | Requirement | | Inv. Ex. 1 | | Comp. Ex. 5 | |
|---|---|---|---|---|---|---|
| | AR | 30 Washes | AR | 30 Washes | AR | 30 Washes |
| Warp Direction | >0.15 | >0.15 | 0.178 | 0.214 | .238 | 0.229 |
| Fill Direction | >0.15 | >0.15 | 0.154 | 0.2 | .186 | 0.236 |

A towel must absorb a large amount of liquid quickly. The wicking test in Table 6 shows the warp direction and fill direction wicking as a function of time. The test takes a 6 inch piece of fabric and measures the vertical wicking of the fabric over time.

TABLE 6
Vertical wicking data AR and after 30 washes

| | |
|---|---|
| Inv. Ex. 1 | Comp. Ex. 5 |

| | AR | 30 Washes | AR | 30 Washes |
|---|---|---|---|---|
| Warp - 1 Min | 1.52 | 3.23 | 1.28 | 3.24 |
| Warp - 3 Min | 2.32 | 4.62 | 1.42 | 4.56 |
| Warp - 5 Min | 2.51 | 5.49 | 2.93 | 5.36 |
| Fill - 1 Min | 1.57 | 3.27 | 1.32 | 3.37 |
| Fill - 3 Min | 2.28 | 4.61 | 1.42 | 4.62 |
| Fill - 5 Min | 2.52 | 5.52 | 2.94 | 5.42 |

The two examples were then tested for how well they would hold up to scrubbing and wiping down tables, as well as pilling and Tinting using the Stoll flat abrasion test according to ASTM D3886-99. Additionally, the two samples were tested for dynamic absorption (AATCC Test Method 70-2000) and total absorption (as described in U.S. Pat. No. 5,308,673, column 9) the results of which are found in Table 7.

TABLE 7
Stoll flat abrasion, dynamic absorption, and total absorption AR and
after 30 washes

| | Requirement | | Inv. Ex. 1 | | |
|---|---|---|---|---|---|
| | | 30 | | 30 | Comp. Ex. 5 |
| | AR | Washes | AR | Washes | 30 Washes |
| Stoll Flat Abrasion (# of | >500 | >500 | 1697 | 1276 | 157/217 |
| cycles) | | | | | |
| Dynamic Absorption as | >120 | >120 | 195.4 | 218.8 | 98.6 |
| a % absorbed | | | | | |
| Total Absorption as a % | >300 | >400 | 280 | 470 | 270 |
| absorbed | | | | | |

The samples were next tested for chlorine resistance. The samples were washed and dried twice in an industrial laundering cycle and then the samples were placed in a 5% bleach solution over night. This cycle was of 2 washes and a bleach soak was repeated and the towels were tested each day (every 2 washes) for physical characteristics. Table 8 shows the tongue tear strength before and after testing and Table 9 shows tensile strength.

TABLE 8
Tongue tear results as received and after bleach testing

| Tongue Tear | |
|---|---|
| (all data in lb-f) | |
| Inv. Ex. 1 | Comp. Ex. 5 |

| | Warp | Fill | Warp | Fill |
|---|---|---|---|---|
| As received | 23.1 | 25.1 | 7.8 | 7.2 |
| 2 washes | 15.8 | 16.9 | 7.3 | 4.7 |
| 4 washes | 11.8 | 13.1 | 5.4 | 3.4 |
| 6 washes | 12.2 | 12.2 | 4.9 | 4.1 |
| 8 washes | 11.1 | 12.1 | 3.7 | 2.3 |
| 10 washes | 10.4 | 11.3 | 3.5 | 1.8 |

TABLE 9
Tensile strength results as received and after bleach testing

| Tensile Strength | |
|---|---|
| (all data in lb-f) | |
| Inv. Ex. 1 | Comp. Ex. 5 |

| | Warp | Fill | Warp | Fill |
|---|---|---|---|---|
| As received | 190.9 | 35.6 | 161.1 | 26.3 |
| 2 washes | 194.5 | 36.0 | 156.4 | 29.9 |
| 4 washes | 169.6 | 41.1 | 162.1 | 22.2 |
| 6 washes | 185.6 | 33.3 | 154.8 | 26.8 |
| 8 washes | 176.5 | 23.5 | 159.7 | 17.2 |
| 10 washes | 171.9 | 22.9 | 163.6 | 14.8 |

As can be seen form the data above, the invention example 1 was superior to the current commercially available cotton towel, comparison example 5, as well as superior to the other comparison examples with different fiber compositions.

It is intended that the scope of the present invention include all modifications that incorporate its principal design features, and that the scope and limitations of the present invention are to be determined by the scope of the appended claims and their equivalents. It also should be understood, therefore, that the inventive concepts herein described are interchangeable and/or they can be used together in still other permutations of the present invention, and that other modifications and substitutions will be apparent to those skilled in the art from the foregoing description of the preferred embodiments without departing from the spirit or scope of the present invention.

What is claimed is:

1. A nonwoven fabric towel comprising:
about 40 to 75% by weight of a first fiber comprising a polyester or polyester co-polymer staple fiber having a staple length of between 3 and 6 inches and a surface area per unit length of between approximately 0.2 micrometer²/cm to 1.2 micrometer²/cm,
about 25 to 50% by weight of a second fiber comprising a multi-segment splitable staple fiber comprising a first component being a polyester or polyester co-polymer component and a second component being a polyamide component or a polyester or polyester co-polymer incompatible with the first component, wherein weight ratio of the first component and the second component is between 40:60 and 80:20, and wherein the first component and the second component have a denier per staple filament of between 0.05 and 0.5, wherein the nonwoven fabric towel is bonded with a stitches of a bulkable yarn, and wherein at least the first or second fiber comprises a hydrophilic surface treatment.

2. The nonwoven fabric towel of claim 1, wherein the first fiber has a denier of between 0.25 and 3.

3. The nonwoven fabric towel of claim 1, wherein the first fiber has a denier of between 2 and 3.

4. The nonwoven fabric towel of claim 1, wherein the polyester or polyester co-polymer of the first fiber is selected from the group consisting of polytrimethylene terephthalate, polycyclohexane dimethylene terephthalate, polybutylene terephthalate, polyester terephthalate, polyester terephthalate modified with polyethylene glycol, and polylactic acid.

5. The nonwoven fabric towel of claim 1, wherein the second component in the second fiber is a polymer selected from the group consisting polytrimethylene terephthalate, polycyclohexane dimethylene terephthalate, polybutylene terephthalate, polyester terephthalate, polyester terephthalate modified with polyethylene glycol, and polylactic acid.

6. The nonwoven fabric towel of claim 1, wherein the polyamide component of the second fiber comprises nylon.

7. The nonwoven towel of claim 1, wherein the multi-segment splitable staple fiber is mechanically splitable.

8. The nonwoven fabric towel of claim 1, wherein the first fiber has a round cross-sectional shape.

9. The nonwoven towel of claim 1, wherein the bonding with stitches of a bulkable yarn comprises stitchbonding.

10. The nonwoven towel of claim 1, wherein the bonding with stitches of a bulkable yarn comprises quilting.

11. The nonwoven fabric towel of claim 9, wherein the nonwoven fabric towel is stitchbonded in a herringbone stitch pattern.

12. The nonwoven fabric towel of claim 1, wherein the durable hydrophilic surface treatment is selected from the group consisting of the condensation products of dimethyl terphthalate, ethylene glycol and polyethylene glycol (ethoxylated polyester) and ethoxylated polyamides.

13. The nonwoven fabric towel of claim 12, wherein the hydrophilic surface treatment is remains on the towel in an amount of at least 200 ppm after 30 industrial washes.

14. The nonwoven fabric towel of claim 1, wherein the outer edges of the nonwoven fabric towel are ultrasonically slit and sealed.

15. The nonwoven fabric towel of claim 1, further comprising an antimicrobial chemistry.

16. The nonwoven fabric towel of claim 1, wherein the towel comprises about 50 to 75% by weight the first fiber.

17. The nonwoven fabric towel of claim 1, wherein the first component and the second component of the second fiber have a denier per staple filament of between 0.15 and 0.5.

18. The nonwoven fabric towel of claim 1, wherein the nonwoven fabric towel has a density of between 100 and 250 grams per square meter.

19. The nonwoven fabric towel of claim 1, wherein the nonwoven fabric towel has an absorbency of aqueous solutions of greater than 450% by weight of the towel.

20. The nonwoven fabric towel of claim 1, wherein the nonwoven fabric towel has a grab tensile strength of at least 10 lb-f after 30 industrial washes as tested by ASTM D5034.

21. The nonwoven fabric towel of claim 1, wherein the nonwoven fabric towel has a tongue tear strength of at least 10 lbf after 30 industrial washes as tested by ASTM D2261.

22. The nonwoven fabric towel of claim 1, wherein the nonwoven fabric towel has at least 400% absorption of water after 30 industrial washes.

23. The nonwoven fabric towel of claim 1, wherein the nonwoven fabric towel has a tongue tear of at least 10 lb-f in the warp and weft directions and a tensile strength of at least 50 lb-f in the warp and weft directions after being subjected to a series of 2 industrial washes and dryings and an overnight soaking in a 5% bleach solution repeated 5 times.

24. A process for forming a nonwoven fabric towel comprising: forming a nonwoven fabric comprising:
about 40 to 75% by weight of a first fiber comprising a polyester or polyester co-polymer staple fiber having a staple length of between 3 and 6 inches and a surface area per unit length of between approximately 0.2 micrometer²/cm to 1.2 micrometer²/cm, and
about 25 to 50% by weight of a second fiber comprising a multi-segment splitable staple fiber comprising a first component being a polyester or polyester co-polymer component and a second component being a polyamide component or a polyester or polyester co-polymer incompatible with the first component, wherein weight ratio of the first component and the second component is between 40:60 and 80:20, and wherein the first component and the second component have a denier per staple filament of between 0.05 and 0.5, wherein at least the first or second fiber comprises a hydrophilic surface treatment;
bonding the nonwoven fabric with a stitches of a bulkable yarn; and, ultrasonically slitting and sealing the nonwoven towel.
